(19) United States
(12) Patent Application Publication
(10) Pub. No.: US 2024/0086298 A1
(43) Pub. Date: Mar. 14, 2024

(54) ANOMALY DETECTION AND SUBSEGMENT ANALYSIS

(71) Applicant: Content Square SAS, Paris (FR)

(72) Inventors: Mohamed-Amine Baatout, Paris (FR); Bharath Aasuri Sridharan, Paris (FR); Daria Stefic, Paris (FR)

(21) Appl. No.: 17/940,450

(22) Filed: Sep. 8, 2022

(51) Int. Cl. G06F 11/34; G06F 16/954; G06F 16/955; G06K 9/62; G06N 20/20

(52) U.S. Cl. CPC G06F 11/3438; G06F 16/954; G06F 16/955; G06K 9/6227; G06N 20/20

(57) ABSTRACT

Systems and techniques may be used for generating an alert for a website based on user interactions at the website using a machine learning trained model. A technique may include receiving user interaction metrics corresponding to the user interactions, determining, using the machine learning trained model, whether a trajectory of a metric of the user interaction metrics is predicted to traverse a threshold, and in response to determining that the trajectory is predicted to traverse the threshold at a particular time, generating the alert. The technique may include evaluating a set of subsegments of the metric, each subsegment of the set of subsegments corresponding to respective metric source attributes, determining, based on the evaluation, at least one subsegment of the set of subsegments that most contributed to the trajectory, and outputting an indication for display, the indication including identification of the at least one subsegment with the alert.

### BACKGROUND

Web commerce has become a nearly universal way to sell products. Managing web commerce websites is often done by a team of people, who use web analytics to make design, structural, and interactive choices for the web commerce websites. Sales data from a website may be used to determine whether a product is successful. However, the sales data does not tell the entire story, nor does it provide sufficient data to make proactive decisions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed in accordance with some examples.

FIG. 2 is a diagrammatic representation of an experience analytics system that has both client-side and server-side functionality in accordance with some examples.

FIG. 3 is a diagrammatic representation of a data structure as maintained in a database in accordance with some examples.

FIG. 4 is a flowchart for a process in accordance with some examples.

FIG. 5 is a diagrammatic representation of a machine in the form of a computer system within which a set of instructions may be executed for causing the machine to perform any one or more of the methodologies discussed herein in accordance with some examples.

FIG. 6 is a block diagram showing a software architecture within which examples may be implemented in accordance with some examples.

FIGS. 7-10 are example user interfaces showing anomaly detection or subsegment analysis, in accordance with some examples.

FIG. 11 illustrates a machine learning engine for training and execution related to anomaly detection or subsegment analysis in accordance with some embodiments.

### DETAILED DESCRIPTION

Systems and techniques described herein provide an alert when an insight or metric exceeds a predicted range, resulting an anomaly. Anomaly detection may be used to trigger a determination of a subsegment of a signal of the insight or metric that is causing the anomaly. An insight or metric may include various interactions at a website, such as traffic, conversions, attractiveness, etc. A subsegment may correspond to sets of user attributes, such as a user device type, a browser type used to access the website, a country of a user accessing the website, a platform, a location, a website source (e.g., a link in an email, a social media advertisement, a search engine link, etc.), a user status (e.g., returning or new, logged in or guest, etc.), or the like. In some examples, subsegments may be further divided into groups, such as by combining two or more subsegments (e.g., browser and device, device and platform and browser, etc.).

The systems and techniques described herein provide a subsegment analysis using a model (e.g., a machine learning trained model) to determine a subsegment (or optionally a subsegment type) related to an anomaly. The subsegment related to the anomaly may be a greatest contributor to the anomaly, a least contributor to the anomaly, a subsegment that had a greatest deviation from its predicted value during the anomaly, etc.

In an example, a model may be used to predict future values of an insight or metric (e.g., after a particular time period has elapsed). When data corresponding to the predicted future values for the insight or metric is received, an anomaly may be indicated when the data is outside of a range of the predicted future values. The data may be used to update the model, in some examples. The model may be selected from a set of models for a particular insight or metric, or client.

### Networked Computing Environment

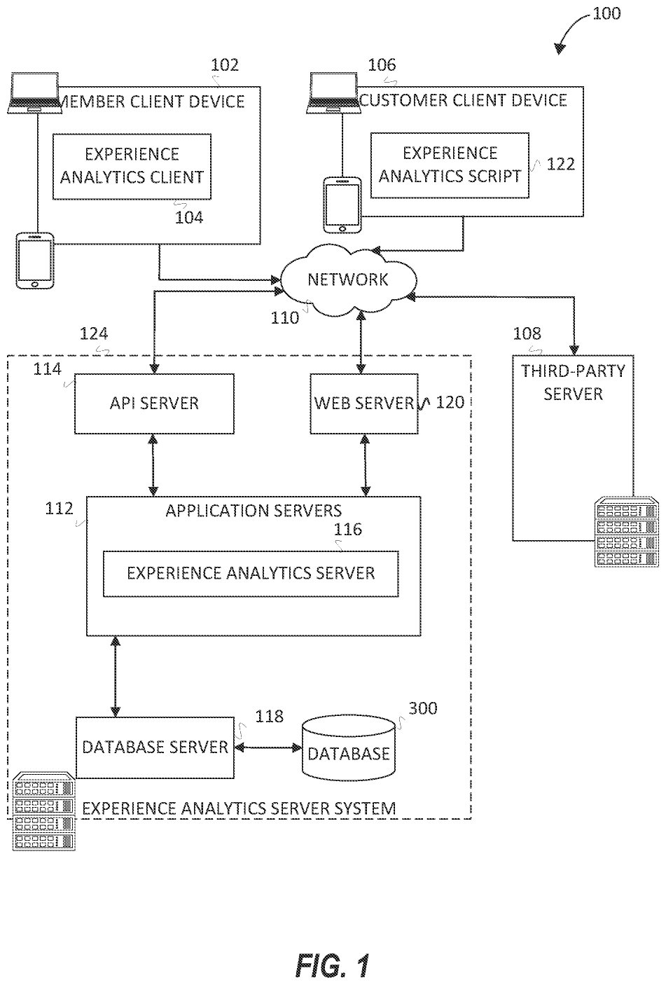

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client's third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client's websites that are hosted on the third-party servers 108 via the network 110 using the Internet browsing applications. For example, the users of the customer client device 106 can navigate to a client's online retail website to purchase goods or services from the website. While the user of the customer client device 106 is navigating the client's website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client's website and processed by the Internet browsing application on the customer client device 106. The experience analytics script 122 can incorporate a scripting language (e.g., a.*js file or a .json file).

In certain examples, a client's native application (e.g., ANDROID™ or IOS™ Application) is downloaded on the customer client device 106. In this example, the client's native application including the experience analytics script 122 is programmed in JavaScript leveraging a Software Development Kit (SDK) provided by the experience analytics server system 124. The SDK includes Application Programming Interfaces (APIs) with functions that can be called or invoked by the client's native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 116, in view of the hardware requirements for such processing.

### System Architecture

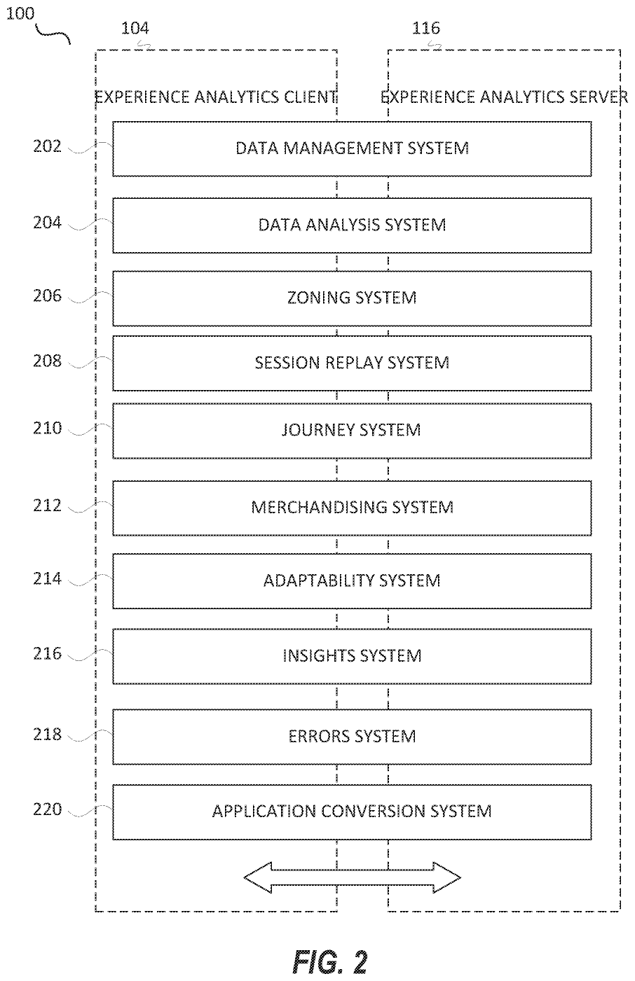

FIG. 2 is a block diagram illustrating further details regarding the experience analytics system 100 according to some examples. Specifically, the experience analytics system 100 is shown to comprise the experience analytics client 104 and the experience analytics server 116. The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the member client device 102 via the experience analytics client 104. The zoning interface provides a visualization of how the users via the customer client devices 106 interact with each element on the client's website. The zoning interface can also provide an aggregated view of in-page behaviors by the users via the customer client device 106 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the member client device 102. In one example, the data can be generated using information from the data analysis system 204.

The session replay system 208 is responsible for generating the session replay interface to be displayed by the member client device 102 via the experience analytics client 104. The session replay interface includes a session replay that is a video reconstructing an individual user's session (e.g., visitor session) on the client's website. The user's session starts when the user arrives at the client's website and ends upon the user's exit from the client's website. A user's session when visiting the client's website on a customer client device 106 can be reconstructed from the data received from the user's experience analytics script 122 on customer client devices 106. The session replay interface can also include the session replays of a number of different visitor sessions to the client's website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website, and illustrates the visited pages and in order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's website to be displayed by the customer client devices 106 for users that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client's website is needed, and can generate the accessibility-enhanced version of the client's website to be displayed by the customer client device 106.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey on the website and the page that adversely affects (e.g., causes frustration for) the users (e.g., users on customer client devices 106 visiting the client's website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client's website to a client's native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client's mobile application to be displayed by the customer client devices 106.

The data management system 202 may store pageviews or unit prices corresponding to out of stock items. The data analysis system 204 may use the stored pageviews or unit prices, for example along with an average conversion rate, to determine a loss indicator for the out of stock item. The average conversion rate may be stored at the data management system 202. The loss indicator may be output from the experience analytics server 116, for example to a user device for display.

### Data Architecture

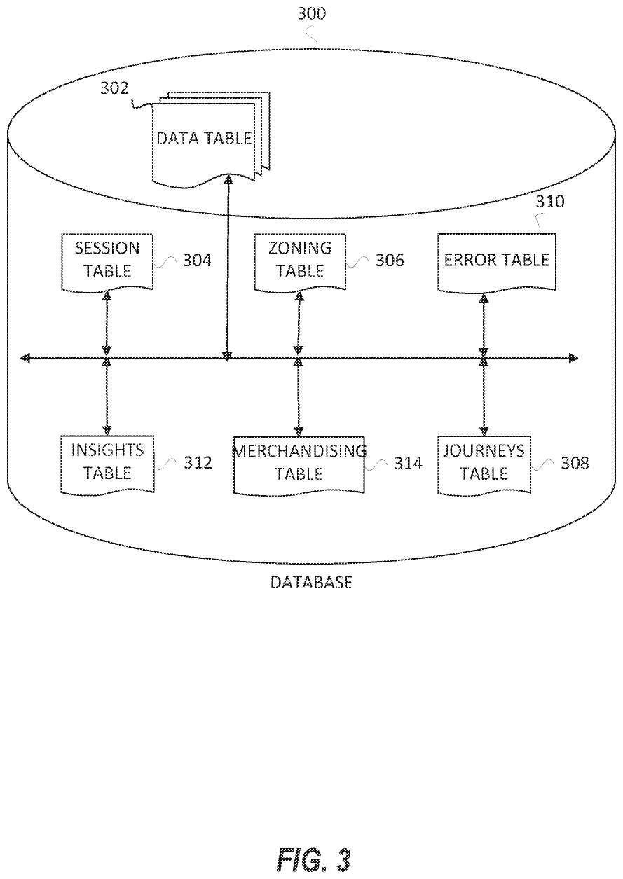

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications.

The zoning table 306 stores data related to the zoning for each of the client's websites and native applications including the zones to be created and the zoning overlay associated with the websites and native applications.

The journeys table 308 stores data related to the journey of each visitor to the client's website or through the native application.

The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

### Process

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

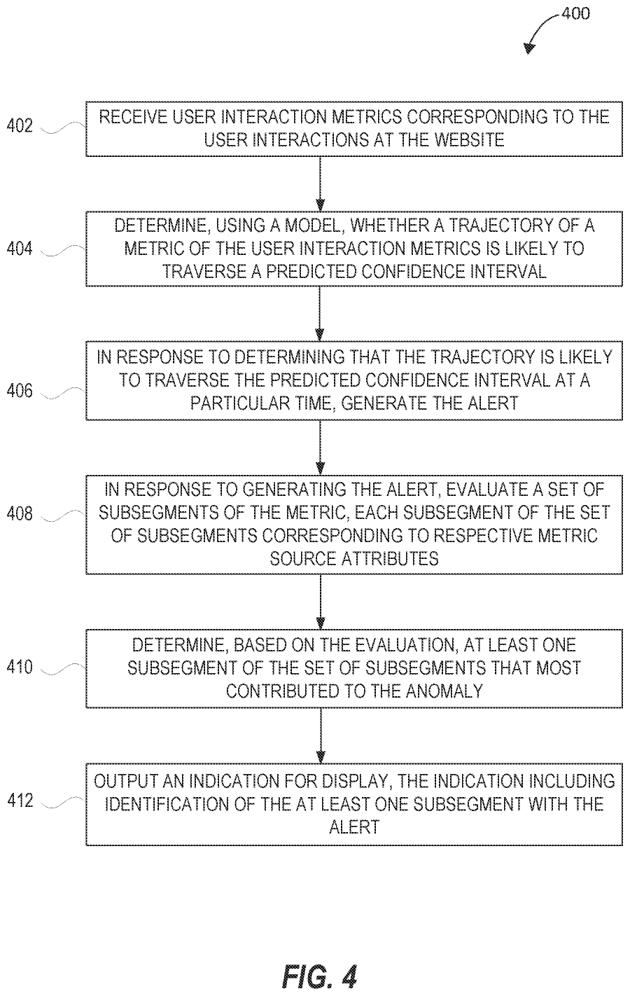

FIG. 4 is a schematic diagram illustrating a process 400, for generating an alert for a website based on user interactions at the website using a machine learning trained model.

The process 400 includes an operation 402 to receive, at a processor, user interaction metrics corresponding to the user interactions at the website.

The process 400 includes an operation 404 to determine, using a machine learning trained model, whether a trajectory of a metric of the user interaction metrics is likely to traverse a predicted confidence interval. The machine learning trained model may be trained using key performance indicator (KPI) data as an input, the input labeled according to whether the KPI data corresponds to an anomalous event. The metric may include at least one of a total user visit count, a total user conversion rate, a total user bounce rate, or the like.

The process 400 includes an operation 406 to in response to determining that the trajectory is likely to traverse the predicted confidence interval at a particular time, generate the alert. Operation 406 may include determining the predicted confidence interval over a future time period, extrapolating the trajectory of the metric to an end of the time period and determining whether the metric is predicted to be within the predicted confidence interval at the end of the time period.

The process 400 includes an operation 408 to in response to generating the alert, evaluate, at the processor, a set of subsegments of the metric, each subsegment of the set of subsegments corresponding to respective metric source attributes. In an example, the respective metric source attributes include at least one of a user device type, a browser type used to access the website, a country of a user accessing the website, a website source, a user operating system, a user type (e.g., returning or new user, logged in or not logged in user, etc.), or the like. The website source may include at least one of a link in an email, a social media advertisement, a search engine link, etc. In an example, the user interaction metrics include a time series of data corresponding to the metric. In this example, operation 408 may include evaluating respective portions of the time series of data corresponding to each of the set of subsegments.

The process 400 includes an operation 410 to determine, based on the evaluation, at least one subsegment of the set of subsegments that most contributed to the anomaly (e.g., via evaluating the trajectory).

The process 400 includes an operation 412 to output an indication for display, the indication including identification of the at least one subsegment with the alert.

The process 400 may include before using the machine learning trained model, selecting the machine learning trained model from a set of at least two models based on benchmarking and the metric. In some examples, the process 400 includes determining whether the metric traversed the predicted confidence interval at the particular time, and in response to determining that the metric did not traverse the predicted confidence interval at the particular time, canceling the alert (which may include suppressing the alert or not triggering the alert). In these examples, the process 400 may include using the determination of whether the metric traversed the predicted confidence interval at the particular time to improve the machine learning trained model.

### Machine Architecture

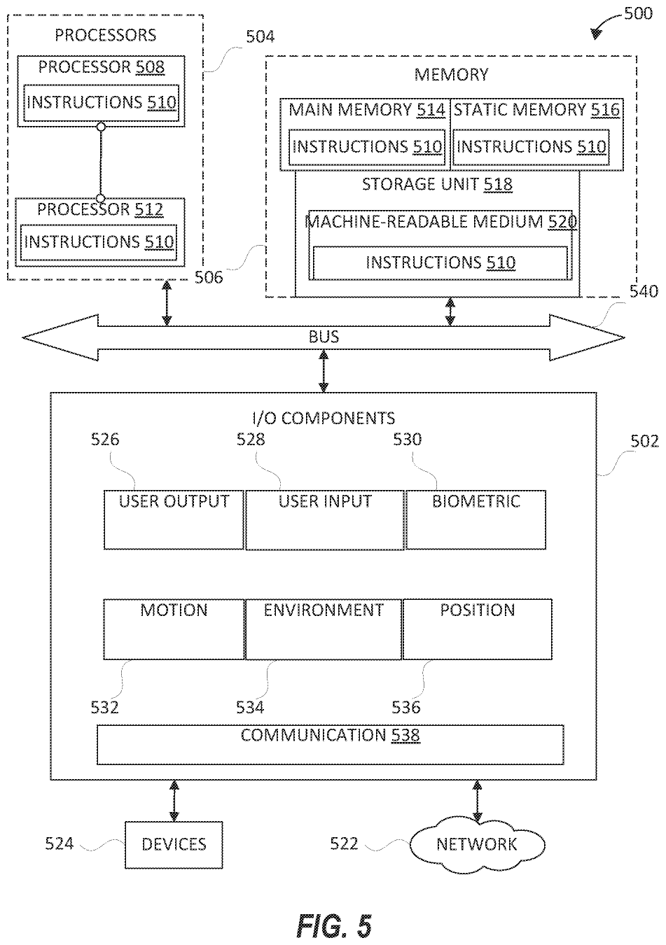

FIG. 5 is a diagrammatic representation of the machine 500 within which instructions 510 (e.g., software, a program, an application, an applet, an application, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while only a single machine 500 is illustrated, the term “machine” shall also be taken to include a collection of machines that individually or jointly execute the instructions 510 to perform any one or more of the methodologies discussed herein. The machine 500, for example, may comprise the member client device 102 or any one of a number of server devices forming part of the experience analytics server 116. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 502, which may be configured to communicate with each other via a bus 540. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 508 and a processor 512 that execute the instructions 510. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, completely or partially, within the main memory 514, within the static memory 516, within machine-readable medium 520 within the storage unit 518, within at least one of the processors 504 (e.g., within the processor's cache memory), or any suitable combination thereof, during execution thereof by the machine 500.

The I/O components 502 may include a wide variety of components to receive input, provide output, produce output, transmit information, exchange information, capture measurements, and so on. The specific I/O components 502 that are included in a particular machine will depend on the type of machine. For example, portable machines such as mobile phones may include a touch input device or other such input mechanisms, while a headless server machine will likely not include such a touch input device. It will be appreciated that the I/O components 502 may include many other components that are not shown in FIG. 5. In various examples, the I/O components 502 may include user output components 526 and user input components 528. The user output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 532 include acceleration sensor components (e.g., accelerometer), gravitation sensor components, rotation sensor components (e.g., gyroscope).

The environmental components 534 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 360° camera for capturing 360° photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 536 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface component or another suitable device to interface with the network 522. In further examples, the communication components 538 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, location via detecting an NFC beacon signal that may indicate a particular location, and so forth.

The various memories (e.g., main memory 514, static memory 516, and memory of the processors 504) and storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

### Software Architecture

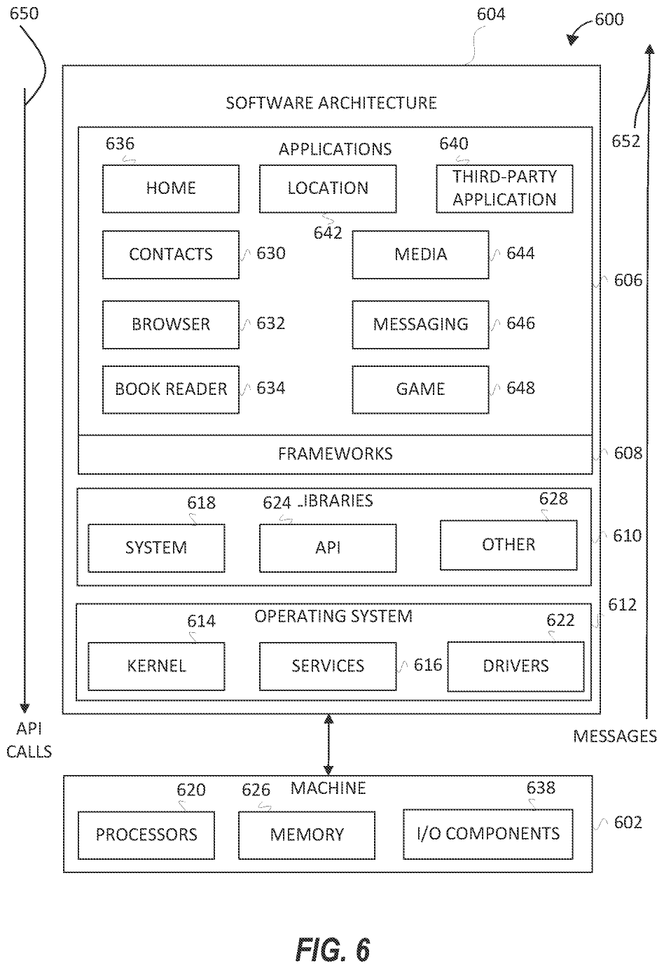

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionalities. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 610 provide a common low-level infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a common high-level infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

### User Interfaces

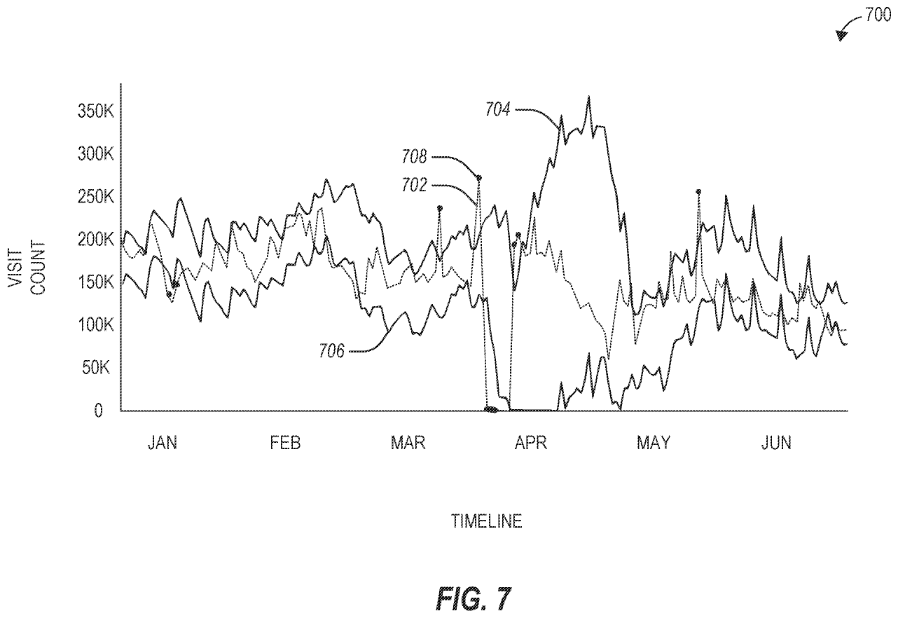

FIGS. 7-10 are example user interfaces showing anomaly detection or subsegment analysis, in accordance with some examples.

FIG. 7 illustrates an anomaly detection graph 700 with a confidence interval and a measured data value line. The example graph 700 in FIG. 7 is shown for visit counts, but may include any other insight, such as conversions, attractiveness, or the like. The example graph 700 includes an actual measurement line 702 and a predicted confidence interval (e.g., a predicted range region) defined by an upper bound line 704 and a lower bound line 706.

The upper bound line 704 and the lower bound line 706 may be generated using a model (e.g., a machine learning trained model) based on recent data (e.g., from the actual measurement line 702, which may trail the bound lines by a specified time period, such as five minutes). The model may be trained or generated to output the bound lines using historical data labeled with one or more of anomalies, event identifiers, time of day, sales information, or the like.

The example graph 700 illustrates one or more anomalies, such as anomaly 708 where the actual measurement line 702 deviates from the predicted range (e.g., exceeds the upper bound line 704 or in other examples, the lower bound line 706). The actual measurement line 702 may represent data (e.g., traffic data at a website) over a time period (e.g., every minute, every five minutes, every hour, etc.). When an anomaly (e.g., 708) occurs, an alert may be output.

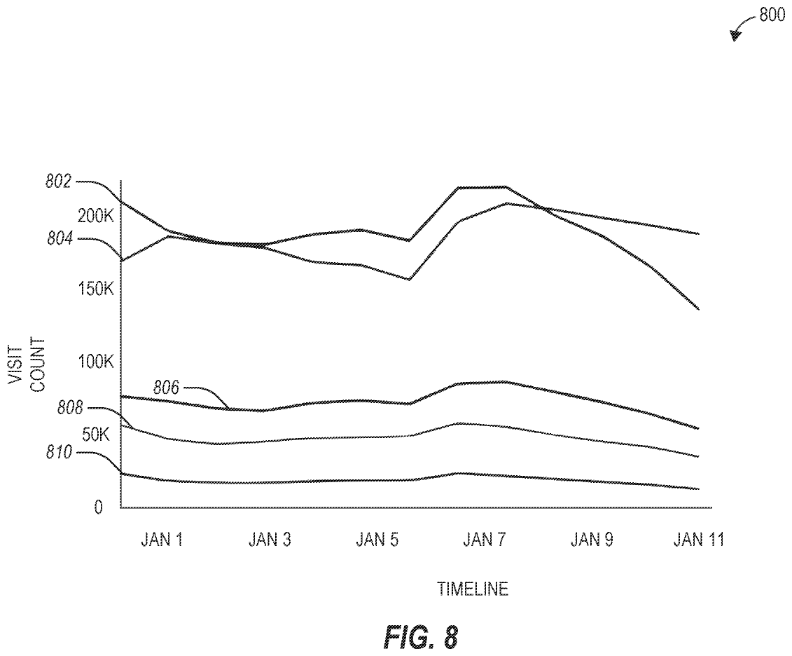

The actual measurement line 702 may be broken down into one or more subsegments, examples of which are described below with respect to FIGS. 8-10. The bound lines 704 or 706 may include subsegment bound lines, which may be used to identify when one or more subsegments has anomalous activity. In an example, when an anomaly is identified for the actual measurement line 702 (e.g., anomaly 708), a subsegment may be identified with an alert (e.g., a subsegment that contributed to the anomaly the most, such as from a number of visits, from a greatest deviation from the subsegment's particular expected value, etc.).

In some examples, the anomaly 708 may be driven by a particular subsegment. In certain cases, the particular subsegment may be not be acting anomalously, but when driving the overall traffic or other data, the anomaly 708 may appear. For example, a large amount of traffic may be driven by a particular device going to a merchant website. When a manufacturer of that particular device releases a new accessory, for example, the traffic coming from the particular device may be increased, although other traffic is not. In some cases, the release of the new accessory may correspond to a particular time, preventing the model related to the actual measurement line 702 from accurately predicting the bound lines.

Subsegments may include contextual user parameters, such as country, device, browser, platform, location, referral URLs, returning or new user, logged in or guest user, or the like. In some examples, subsegments may be further divided into groups, such as by combining two or more subsegments (e.g., browser and device, device and platform and browser, etc.).

When an anomaly is identified, subsegments may be checked to determine whether the contribution of a subsegment is in line with an expected identified subsegments performance. This process may include determining whether any subsegments caused an anomaly, and if so, determining which subsegment caused the anomaly. Subsegment contribution to the actual measurement line 702 may be quantified using equations discussed below, in some examples. An equation may quantify independent subsegment deviations (e.g., contribution of the actual measurement line 702 is seen independently for each subsegment as observed change from its expected (e.g., predicted) value). An equation may quantify weighted subsegment deviations (e.g., where the above equation is weighted by ratio of a subsegment's expectation in the total actual measurement line 702 expectation). An equation may quantify contribution in change (e.g., a contribution of the actual measurement line 702 is seen as ratio of its contributing amount in the total change amount).

In some examples, the example graph 700 may be constructed using various parameters, such as a sliding window of 30 days fit data, with a one day prediction, linear or exponential (or no) growth, seasonality parameters (e.g., a holiday), confidence interval parameters (e.g., separation of the bound lines from a predicted value), standard error of differences between predicted values and the actual measurement line 702, a standard deviation weighting, sensitivity, or the like.

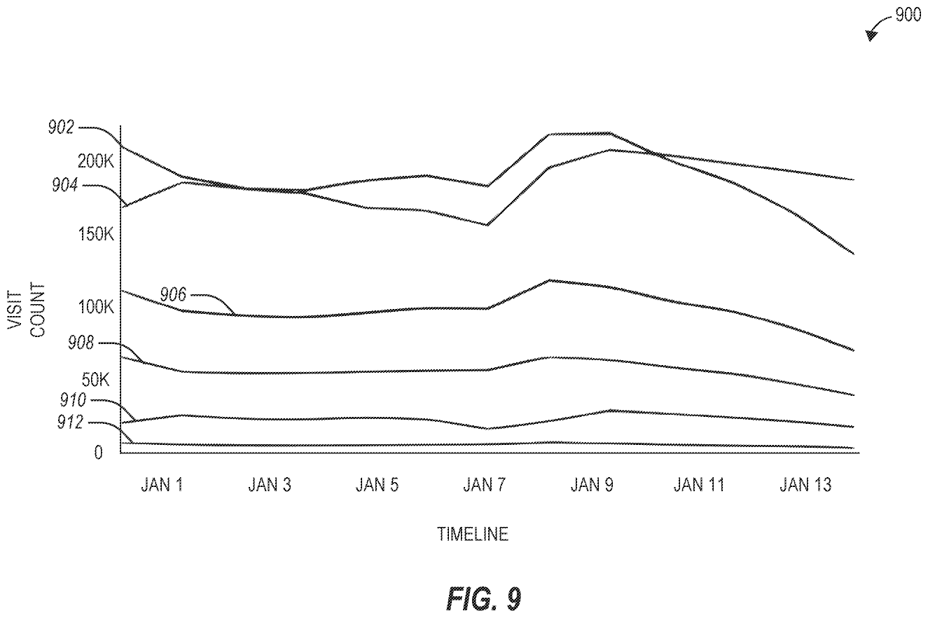

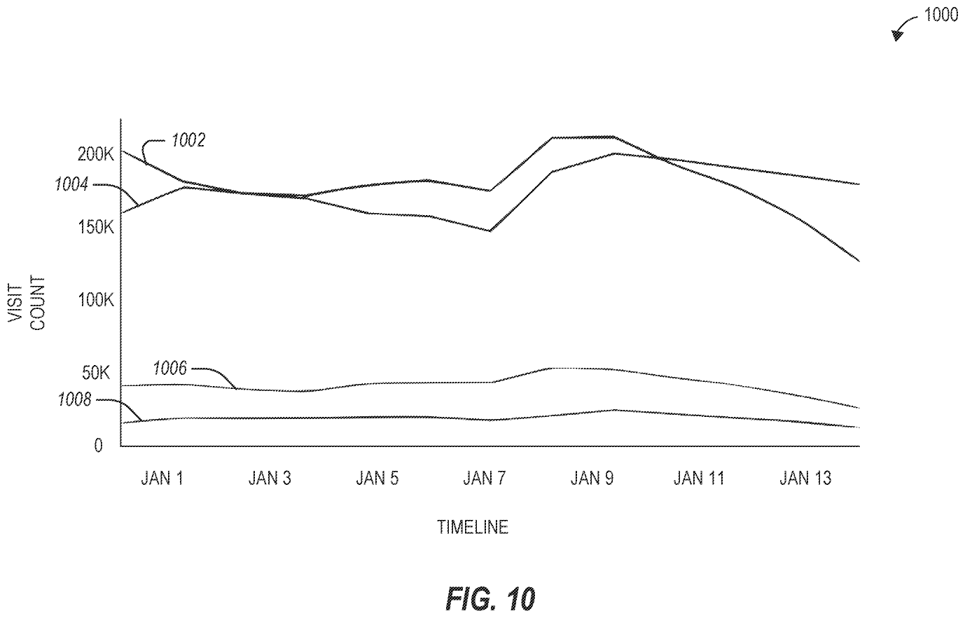

FIGS. 8-10 show example subsegment representation graphs, such as browser type in FIG. 8, device or operating system type in FIG. 9, and referral or access type in FIG. 10. These graphs are illustrative of different types of subsegments, but are not intended to be limiting. Other types of subsegments may be used (e.g., country or location of device, battery status of device, user status, such as logged in, guest, returning, new user, etc., platform, or the like), combinations of two or more subsegments may be used, or the like.

FIG. 8 includes a graph 800, which shows an actual data line 802, a prediction line 804, and three example subsegment lines 806, 808, and 810. The subsegment lines 806, 808, and 810 may include subsegments of a particular subsegment type. The graph 800 may omit one or more segments (e.g., segments below a threshold). In some examples, one or more segments may be combined (e.g., into a remaining segments line).

FIG. 9 illustrates a graph 900, which shows an actual data line 902, a prediction line 904, and four example subsegment lines 906, 908, 910, and 912. The subsegment lines 906, 908, 910, and 912 may include subsegments of a particular subsegment type. In an example, the subsegment type may include a device type, with segments including Android, iPhone, Apple, PC, etc. or an operating system, with segments including Android, iOS, Mac OS X, Windows, etc.

FIG. 10 illustrates a graph 1000, which shows an actual data line 1002, a prediction line 1004, and three example subsegment lines 1006 and 1008. The subsegment lines 1006 and 1008 may include subsegments of a particular subsegment type. In an example, the segment type may include country of origin, referral link, or the like. For example, the segments may include an affiliation link, a direct link, an email link a referral link, a social network link, etc.

Typically, the subsegments follow the main segment. In some examples, a particular subsegment or set of subsegments may be more or less influential on a merchant website (e.g., there may be variance among merchant websites for which subsegments cause anomalies). In some examples, a particular subsegment or set of subsegments may be more or less influential on a particular metric (e.g., one subsegment may cause anomalies for traffic, while another causes anomalies for conversions). A subsegment relevance score may be determined, for example as the standard deviation of the contribution numbers of subsegments in question, using heuristics, based on a series of filtering equations (e.g., using Eq. 1 to filter out many candidates, and using Eq. 3 to rank the remaining subsegments after filtering). Subsegments may be ranked by the relevance score. When an anomaly occurs, the subsegment with the highest relevance score may be output with an alert. In some examples, a subsegment may be excluded (e.g., country of origin) when the data does not change or has few changes (e.g., excluding countries with only a few users visiting the website).

In some examples, all subsegments may seem relevant to the overall segment, such as when the subsegments largely track the segment movement. In these examples, a highest volume value subsegment may be relevant to cause an anomaly due to its high volume overwhelming other subsegment values.

In an example of a rising anomaly, subsegments that contributed the least to the rising anomaly may be identified. For example, when a particular value of a subsegment contributes the least to a rising anomaly, it may be identified as causing the model to limit the predicted value (e.g., falsely limiting the upper bound). In this example, the value least contributing may be the anomalous value, rather than the highest contributing one.

In some examples, an erroneous prediction for an upper or lower bound or a predicted value of a subsegment may cause an anomaly. The erroneous prediction may cause a contribution number to be unrealistically high. A high contribution number may cause the subsegment relevance to be high and render the analysis incorrect. To improve predicted values, a value may be checked using proxy methods (e.g., machine learning or other algorithm), such as a last value, an average over an immediately previous time period, a value or average value from a previous time period (e.g., a previous year for a similar or same week), etc.

In some examples an analysis of subsegment contribution to an anomaly may use two or more of the equations described herein. In an example, rising or falling anomalies may be treated differently, such as identifying a most contributing subsegment or subsegment value for falling anomalies and a least contributing subsegment or subsegment value for rising anomalies (e.g., in the case of website traffic). The use of most or least contributing subsegment or subsegment value (e.g., to be output with an alert about an anomaly) may be determined based on the type of data (e.g., traffic, conversions, attractiveness, interactions, etc.). In some examples, multiple subsegments may be relevant, and more than one subsegment may be output with an alert. A threshold for relevant subsegments may be used.

Subsegment analysis may include determining quantification for contribution by each subsegment (or a set of subsegments, such as leaving out those below a threshold) in a particular subsegment type (e.g., where a subsegment type includes at least one of a user device type, a browser type used to access the website, a country of a user accessing the website, a platform, a location, a website source, a user status, etc.).

To analyze a user context subsegment type, an equation 1 may be used:

Yₜₒₜₐₗ(t)=Y₁(t)+ . . . +Yₙ(t) Eq. 1

In Eq. 1, n is number of subsegments, Y_total is the overall signal value, and each of Y_1 to Y_n are subsegment values. Eq. 1 indicates that when an anomaly occurs, Y_total(t) deviates from an expected value, and one or more of the subsegments Y_i(t) may deviate from their expected values. By observing the subsegments and their deviations or other aspects of their behavior, how much each of the subsegments (or how much one subsegment) contributed to the anomaly may be quantified. A contribution of each subsegment i may be indicated as C_i.

In the following table 1, expected and anomalous values of an observed metric for two subsegments s1 and s2 are shown with s_total, the main segment (e.g., where s_total=s1+s2). From these values, contribution values C_1 and C_2 may be calculated for subsegments s1 and s2, respectively.

TABLE 1

| | s1 | s2 | s_total |
|---|---|---|---|
| Expected | 60 | 10 | 70 |
| value − Y\hat{ }exp | | | |
| Anomalous | 80 | 20 | 100 |
| value − Y\hat{ }gt | | | |

In this example, each of the subsegments exhibit anomalous behavior. However, it may not be clear which one contributes to the main segment anomaly more. Each of the subsegment anomalies may be analyzed separately. In the example of Table 1, anomalies for S1 and S2 rose by 33% and 100% compared to their expected values, respectively. This change may be defined this as a first contribution equation, Eq. 2:

$$\\ \begin{matrix}{Cdev}_{i} = \frac{{Y}_{i}^{gt}}{{Y}_{i}^{exp}} - 1 & Eq . 2\end{matrix}$$

The number is higher for S2, but its total values are lower than S1, so while the percentage change is high, the contribution may not be significant. Eq. 3 below shows a second contribution equation that uses weights by average expected contribution:

$$\\ \begin{matrix}{Cdevw}_{i} = ( \frac{{Y}_{i}^{gt}}{{Y}_{i}^{exp}} - 1 ) * {w}_{i} & Eq . 3\end{matrix}$$

$$\\ {w}_{i} = \frac{{Y}_{i}^{exp}}{{Y}_{total}^{exp}}$$

Updated Table 1 with these new values is shown as Table 2:

TABLE 2

| | s1 | s2 | s_total |
|---|---|---|---|
| Expected value | 60 | 10 | 70 |
| Anomalous value | 80 | 20 | 100 |
| Independent deviation | 33% | 100% | 43% |
| from expected − Cdev | | | |
| Average expected | 60/70 = 85% | 10/70 = 15% | |
| contribution − w | | | |
| Weighted independent | 33 × 85 = 28 | 100 × 15 = 15 | |
| deviation from | | | |
| expected − Cdevw | | | |

Table 2 shows that Cdevw has a higher number for S1. A third contribution equation may be used, which includes a total difference in the values that occurred during the anomaly (e.g., 100−70=30), and how much each sub segment contributed to the change. The third contribution equation is Eq. 4:

$$\\ \begin{matrix}{Cdiff}_{i} = \frac{{Y}_{i}^{gt} - {Y}_{i}^{exp}}{{Y}_{total}^{gt} - {Y}_{total}^{exp}} & Eq . 4\end{matrix}$$

The results of Eq. 4 for this example are shown in Table 3:

TABLE 3

| | s1 | s2 | s_total |
|---|---|---|---|
| Expected value | 60 | 10 | 70 |
| Anomalous value | 80 | 20 | 100 |
| Contribution in the | 20/30 = 67% | 10/30 = 33% | |
| change − Cdiff | | | |

In Table 3, the number for S1 is higher, since only the absolute values are shown, while ignoring that S2 has larger deviation but smaller absolute values. A summary is shown in table 4:

TABLE 4

| | s1 | s2 | s_total |
|---|---|---|---|
| Expected value | 60 | 10 | 70 |
| Anomalous value | 80 | 20 | 100 |
| Independent deviation | 33% | 100% | 43% |
| from expected − Cdev | | | |
| Weighted independent deviation | 28 | 15 | |
| from expected − Cdevw | | | |
| Contribution in the | 67% | 33% | |
| change − Cdiff | | | |

Each subsegment may exhibit its own anomalous behavior, but to determine whether that segment contributed to or caused the total anomaly, further contextual information may be used (e.g., Eqs. 1-4). In some examples, other weighting approaches may be used. For example, weighting by past average values, weighting according to data from previous years (e.g., corresponding to a holiday, a week, etc.), weighting according to advertisements, discounts, or sales, weighting according to another insight or metric (e.g., conversion, attractiveness, etc.), or the like.

In the previous example, the contribution was analyzed by considering current values of the main segment and subsegments, and their respective expected values. In a second example, an effect of different expected values on the analysis is discussed. The expected values may include an output of a predictor, which may not always be perfect or entirely accurate. This second example discusses the effects of the precision of the predictor on the contribution analysis. Using the contributions introduced in the above example, Table 5 shows first example expected values:

TABLE 5

| | s1 | s2 | s_total |
|---|---|---|---|
| Expected value 1 | 30 | 30 | 60 |
| Anomalous value | 60 | 40 | 100 |
| Independent deviation | 100% | 33% | 67% |
| from expected − Cdev | | | |
| Weighted independent deviation | 50% | 12.5% | |
| from expected − Cdevw | | | |
| Contribution in the | 75% | 25% | |
| change − Cdiff | | | |

Table 6 shows second example expected values:

TABLE 6

| | s1 | s2 | s_total |
|---|---|---|---|
| Expected value 2 | 50 | 30 | 80 |
| Anomalous value | 60 | 40 | 100 |
| Independent deviation | 20% | 33% | 25% |
| from expected − Cdev | | | |
| Weighted independent deviation | 12.5% | 19% | |
| from expected − Cdevw | | | |
| Contribution in the | 50% | 50% | |
| change − Cdiff | | | |

Table 7 below shows a comparison of chosen subsegments (e.g., subsegments that have higher contribution values C), for each contribution equation C for the two versions of example expected values:

TABLE 7

| | Expected value 1 | Expected value 2 |
|---|---|---|
| Cdev | s1 | s2 |
| Cdevw | s1 | s2 |
| Cdiff | | s1 = s2 |

In this example, for the first example expected values, subsegment S1 is always identified as more contributing, and for the second example expected values, subsegment S2 is identified as more contributing by Cdev and Cdevw (where Cdiff identifies subsegments as equally contributing). The different outcomes may therefore depend on different expected values. The prediction validity may be used as an indicator or check on whether the subsegment analysis is valid. For example, when the actual value differs from the predicted value by more than a threshold, the subsegment may be ignored, or reevaluated with a more accurate prediction (e.g., a floor of the threshold may be used for the predicted value for deviation from the actual value).

### Machine Learning

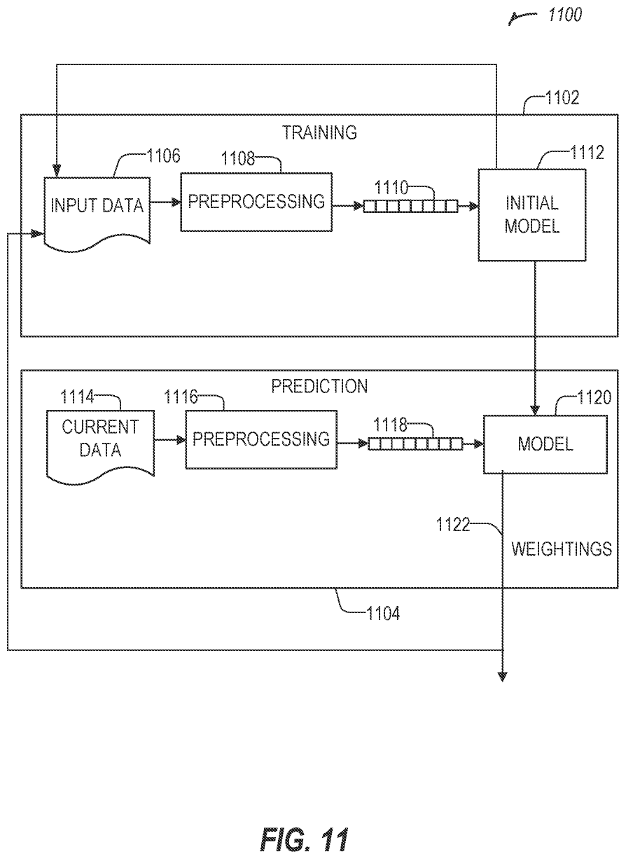

FIG. 11 illustrates a machine learning engine for training and execution related to anomaly detection or subsegment analysis in accordance with some embodiments. The machine learning engine can be deployed to execute at a mobile device (e.g., a cell phone) or a computer. A system may calculate one or more weightings for criteria based upon one or more machine learning algorithms. FIG. 11 shows an example machine learning engine 1100 according to some examples of the present disclosure.

Machine learning engine 1100 utilizes a training engine 1102 and a prediction engine 1104. Training engine 1102 uses input data 1106, after undergoing preprocessing component 1108, to determine one or more features 1110. The one or more features 1110 may be used to generate an initial model 1112, which may be updated iteratively or with future unlabeled data.

The input data 1106 may include previous recorded data for an insight or metric (e.g., a time-series of data), such as overall data or subsegment data, such as when training a model for predicting an anomaly. The input data 1106 in this example may include traffic at a website, conversions (e.g., products on the website that are selected and purchased), attractiveness (e.g., click rate of products shown or loaded), etc. In some examples, multiple models may be generated, such as for each subsegment of a set of subsegments (e.g., of a subsegment type or group of subsegments of a subsegment type). The input data 1106 may include subsegment contribution information (e.g., previous data related to subsegment contribution to an anomaly, such as using Eqs. 1-4 above) when training a model to output a subsegment related to an anomaly. Multiple models may be used, such as one for each subsegment of a set of subsegments.

In the prediction engine 1104, current data 1114 may be input to preprocessing component 1116. In some examples, preprocessing component 1116 and preprocessing component 1108 are the same. The prediction engine 1104 produces feature vector 1118 from the preprocessed current data, which is input into the model 1120 to generate one or more criteria weightings 1122. The criteria weightings 1122 may be used to output a prediction, as discussed further below.

The training engine 1102 may operate in an offline manner to train the model 1120 (e.g., on a server). The prediction engine 1104 may be designed to operate in an online manner (e.g., in real-time, at a mobile device, on a wearable device, etc.). In some examples, the model 1120 may be periodically updated via additional training (e.g., via updated input data 1106, based on labeled or unlabeled data output in the weightings 1122, or using the weightings as input) or based on identified future data. Labels for the input data 1106 may include whether a particular data point corresponds to an anomaly, whether a particular subsegment was related to an anomaly (e.g., caused, was most contributive subsegment, was least contributive subsegment, etc.), or the like. The initial model 1112 may be updated using further input data 1106 until a satisfactory model 1120 is generated. The model 1120 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 1102 or the prediction engine 1104 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 1102. In an example embodiment, a regression model is used and the model 1120 is a vector of coefficients corresponding to a learned importance for each of the features in the vector of features 1110, 1118.

In some examples, clustering methods (e.g., k-means) or random forests, support vector machines (SVMs), or the like may be represented via a scatter plot and anomalies may be shown (e.g., expected) in a low density region. These results may be transformed to a line graph to indicate anomalies (e.g., when displayed on a user interface).

Once trained, the model 1120 may output a predicted next value for a segment or subsegment. In some examples, the model 1120 may output a subsegment related to an anomaly (e.g., a subsegment that caused the anomaly, was most contributive subsegment, was least contributive subsegment, etc.).

In some examples, the model 1120 may be trained to determine whether an anomaly is to be sent to a client. For example, when the anomaly was caused by a prediction for a particular subsegment that was inaccurate beyond a threshold, the anomaly may be suppressed. In other examples, multiple models may be compared. In these examples, when a minimum set of models agree on an anomaly, the anomaly may be output. In some examples, when using multiple models, identification of an anomaly by a primary model (e.g., operating online, in real-time, or in near real-time) may be verified by a secondary model (e.g., a slower or off-line model). The verification may include suppressing indication of the anomaly or retracting indication of the anomaly.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Example 1 is a method comprising: receiving, at a processor, user interaction metrics corresponding to user interactions at a website; determining, using a machine learning trained model, whether a trajectory of a metric of the user interaction metrics is likely to traverse a predicted confidence interval; in response to determining that the trajectory is likely to traverse the predicted confidence interval at a particular time, generating an alert; in response to generating the alert, evaluating, at the processor, a set of subsegments of the metric, each subsegment of the set of subsegments corresponding to respective metric source attributes; determining, based on the evaluation, at least one subsegment of the set of subsegments that most contributed to the anomaly; and outputting an indication for display, the indication including identification of the at least one subsegment with the alert.

In Example 2, the subject matter of Example 1 includes, wherein the respective metric source attributes include at least one of a user device type, a browser type used to access the website, a country of a user accessing the website, a website source, a user operating system, or a user type.

In Example 3, the subject matter of Example 2 includes, wherein the website source includes at least one of a link in an email, a social media advertisement, or a search engine link.

In Example 4, the subject matter of Examples 1-3 includes, wherein the machine learning trained model is trained using key performance indicator (KPI) data as an input, the input labeled according to whether the KPI data corresponds to an anomalous event.

In Example 5, the subject matter of Examples 1-4 includes, wherein the user interaction metrics include a time series of data corresponding to the metric, and wherein evaluating the set of subsegments includes evaluating respective portions of the time series of data corresponding to each of the set of subsegments.

In Example 6, the subject matter of Examples 1-5 includes, wherein determining, using the machine learning trained model, that the trajectory is likely to traverse the predicted confidence interval includes determining the predicted confidence interval over a future time period, extrapolating the trajectory of the metric to an end of the time period, and determining whether the metric is predicted to be within the predicted confidence interval at the end of the time period.

In Example 7, the subject matter of Examples 1-6 includes, wherein the metric includes at least one of a total user visit count, a total user conversion rate, or a total user bounce rate.

In Example 8, the subject matter of Examples 1-7 includes, before using the machine learning trained model, selecting the machine learning trained model from a set of at least two models based on benchmarking and the metric.

In Example 9, the subject matter of Examples 1-8 includes, determining whether the metric traversed the predicted confidence interval at the particular time, and in response to determining that the metric did not traverse the predicted confidence interval at the particular time, canceling the alert.

In Example 10, the subject matter of Example 9 includes, using the determination of whether the metric traversed the predicted confidence interval at the particular time to improve the machine learning trained model.

Example 11 is a computing apparatus, the computing apparatus comprising: a processor; and a memory storing instructions that, when executed by the processor, configure the apparatus to: receive user interaction metrics corresponding to user interactions at a website; determine, using a machine learning trained model, whether a trajectory of a metric of the user interaction metrics is likely to traverse a predicted confidence interval; in response to determining that the trajectory is likely to traverse the predicted confidence interval at a particular time, generate an alert; in response to generating the alert, evaluate a set of subsegments of the metric, each subsegment of the set of subsegments corresponding to respective metric source attributes; determine, based on the evaluation, at least one subsegment of the set of subsegments that most contributed to the anomaly; and output an indication for display, the indication including identification of the at least one subsegment with the alert.

In Example 12, the subject matter of Example 11 includes, wherein the respective metric source attributes include at least one of a user device type, a browser type used to access the website, a country of a user accessing the website, or a website source, a user operating system, or a user type.

In Example 13, the subject matter of Example 12 includes, wherein the website source includes at least one of a link in an email, a social media advertisement, or a search engine link.

In Example 14, the subject matter of Examples 11-13 includes, wherein the machine learning trained model is trained using key performance indicator (KPI) data as an input, the input labeled according to whether the KPI data corresponds to an anomalous event.

In Example 15, the subject matter of Examples 11-14 includes, wherein the user interaction metrics include a time series of data corresponding to the metric, and wherein the instructions to evaluate the set of subsegments, when executed by the processor, configure the apparatus to evaluate respective portions of the time series of data corresponding to each of the set of subsegments.

In Example 16, the subject matter of Examples 11-15 includes, wherein the instructions to determine, using the machine learning trained model, that the trajectory is likely to traverse the predicted confidence interval, when executed by the processor, configure the apparatus to determine the predicted confidence interval over a future time period, extrapolate the trajectory of the metric to an end of the time period, and determine whether the metric is predicted to be within the predicted confidence interval at the end of the time period.

In Example 17, the subject matter of Examples 11-16 includes, wherein the metric includes at least one of a total user visit count, a total user conversion rate, or a total user bounce rate.

In Example 18, the subject matter of Examples 11-17 includes, wherein the instructions, when executed by the processor further configure the apparatus to, before using the machine learning trained model, select the machine learning trained model from a set of at least two models based on benchmarking and the metric.

Example 19 is at least one non-transitory machine-readable medium including instructions, which when executed by processing circuitry, cause the processing circuitry to perform operations to: receive user interaction metrics corresponding to user interactions at a website; determine, using a machine learning trained model, whether a trajectory of a metric of the user interaction metrics is likely to traverse a predicted confidence interval; in response to determining that the trajectory is likely to traverse the predicted confidence interval at a particular time, generate an alert; in response to generating the alert, evaluate a set of subsegments of the metric, each subsegment of the set of subsegments corresponding to respective metric source attributes; determine, based on the evaluation, at least one subsegment of the set of subsegments that most contributed to the anomaly; and output an indication for display, the indication including identification of the at least one subsegment with the alert.

In Example 20, the subject matter of Example 19 includes, determining whether the metric traversed the predicted confidence interval at the particular time, and in response to determining that the metric did not traverse the predicted confidence interval at the particular time, canceling the alert, and further comprising using the determination of whether the metric traversed the predicted confidence interval at the particular time to improve the machine learning trained model.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

1. A method comprising:
receiving, at a processor, user interaction metrics corresponding to user interactions at a website;
determining, at a current time using a machine learning trained model, whether a trajectory of a metric of the user interaction metrics is likely to traverse a predicted confidence interval at a particular future time;
generating an alert in response to determining that the trajectory is likely to traverse the predicted confidence interval at the particular future time, the determination that the trajectory is likely to traverse the predicted confidence interval indicating an anomaly;
in response to generating the alert, evaluating, at the processor, a set of subsegments of the metric potentially linked to the anomaly, each subsegment of the set of subsegments corresponding to respective metric source attributes;
determining, based on the evaluation, at least one subsegment of the set of subsegments that most contributed to the trajectory being determined to likely traverse the predicted confidence interval indicating the anomaly; and
outputting an indication for display, the indication including identification of the at least one subsegment with the alert.

2. The method of claim 1, wherein the respective metric source attributes include at least one of a user device type subsegment, a browser type used to access the website subsegment, a country of a user accessing the website subsegment, a website source subsegment, a user operating system subsegment, or a user type subsegment.

3. The method of claim 2, wherein the website source subsegment includes values of at least one of a link in an email, a social media advertisement, or a search engine link.

4. The method of claim 1, wherein the machine learning trained model is trained using key performance indicator (KPI) data as an input, the input labeled according to whether the KPI data corresponds to an anomalous event.

5. The method of claim 1, wherein the user interaction metrics include a time series of data corresponding to the metric, and wherein evaluating the set of subsegments includes evaluating respective portions of the time series of data corresponding to each of the set of subsegments.

6. The method of claim 1, wherein determining, using the machine learning trained model, that the trajectory is likely to traverse the predicted confidence interval includes determining the predicted confidence interval over a future time period, extrapolating the trajectory of the metric to an end of the time period, and determining whether the metric is predicted to be within the predicted confidence interval at the end of the time period.

7. The method of claim 1, wherein the metric includes at least one of a total user visit count, a total user conversion rate, or a total user bounce rate.

8. The method of claim 1, further comprising, before using the machine learning trained model, selecting the machine learning trained model from a set of at least two models based on benchmarking and the metric.

9. The method of claim 1, further comprising, determining whether the metric traversed the predicted confidence interval at the particular time, and in response to determining that the metric did not traverse the predicted confidence interval at the particular time, canceling the alert.

10. The method of claim 9, further comprising using the determination of whether the metric traversed the predicted confidence interval at the particular time to improve the machine learning trained model.

11. A computing apparatus, the computing apparatus comprising:
a processor; and
a memory storing instructions that, when executed by the processor, configure the apparatus to:
receive user interaction metrics corresponding to user interactions at a website;
determine, at a current time using a machine learning trained model, whether a trajectory of a metric of the user interaction metrics is likely to traverse a predicted confidence interval at a particular future time;
generate an alert in response to determining that the trajectory is likely to traverse the predicted confidence interval at the particular future time, the determination that the trajectory is likely to traverse the predicted confidence interval indicating an anomaly at the particular future time;
in response to generating the alert, evaluate a set of subsegments of the metric potentially linked to an anomaly, each subsegment of the set of subsegments corresponding to respective metric source attributes;
determine, based on the evaluation, at least one subsegment of the set of subsegments that most contributed to the trajectory being determined to likely traverse the predicted confidence interval indicating the anomaly; and
output an indication for display, the indication including identification of the at least one subsegment with the alert.

12. The computing apparatus of claim 11, wherein the respective metric source attributes include at least one of a user device type subsegment, a browser type used to access the website subsegment, a country of a user accessing the website subsegment, or a website source subsegment, a user operating system subsegment, or a user type subsegment.

13. The computing apparatus of claim 12, wherein the website source subsegment includes values of at least one of a link in an email, a social media advertisement, or a search engine link.

14. The computing apparatus of claim 11, wherein the machine learning trained model is trained using key performance indicator (KPI) data as an input, the input labeled according to whether the KPI data corresponds to an anomalous event.

15. The computing apparatus of claim 11, wherein the user interaction metrics include a time series of data corresponding to the metric, and wherein the instructions to evaluate the set of subsegments, when executed by the processor, configure the apparatus to evaluate respective portions of the time series of data corresponding to each of the set of subsegments.

16. The computing apparatus of claim 11, wherein the instructions to determine, using the machine learning trained model, that the trajectory is likely to traverse the predicted confidence interval, when executed by the processor, configure the apparatus to determine the predicted confidence interval over a future time period, extrapolate the trajectory of the metric to an end of the time period, and determine whether the metric is predicted to be within the predicted confidence interval at the end of the time period.

17. The computing apparatus of claim 11, wherein the metric includes at least one of a total user visit count, a total user conversion rate, or a total user bounce rate.

18. The computing apparatus of claim 11, wherein the instructions, when executed by the processor further configure the apparatus to, before using the machine learning trained model, select the machine learning trained model from a set of at least two models based on benchmarking and the metric.

19. At least one non-transitory machine-readable medium including instructions, which when executed by processing circuitry, cause the processing circuitry to perform operations to:
receive user interaction metrics corresponding to user interactions at a website;
determine, at a current time using a machine learning trained model, whether a trajectory of a metric of the user interaction metrics is likely to traverse a predicted confidence interval at a particular future time;
generate an alert in response to determining that the trajectory is likely to traverse the predicted confidence interval at the particular future time, the determination that the trajectory is likely to traverse the predicted confidence interval indicating an anomaly;
in response to generating the alert, evaluate a set of subsegments of the metric potentially linked to the anomaly, each subsegment of the set of subsegments corresponding to respective metric source attributes;
determine, based on the evaluation, at least one subsegment of the set of subsegments that most contributed to the trajectory being determined to likely traverse the predicted confidence interval indicating the anomaly; and
output an indication for display, the indication including identification of the at least one subsegment with the alert.

20. The at least one non-transitory machine-readable medium of claim 19, further comprising, determining whether the metric traversed the predicted confidence interval at the particular time, and in response to determining that the metric did not traverse the predicted confidence interval at the particular time, canceling the alert, and further comprising using the determination of whether the metric traversed the predicted confidence interval at the particular time to improve the machine learning trained model.
